(19) United States
(12) Patent Application Publication
(10) Pub. No.: US 2024/0327557 A1
(43) Pub. Date: Oct. 3, 2024

(54) WATERBORNE POLYMERS

(71) Applicant: ROHM AND HAAS COMPANY, Collegeville, PA (US)

(72) Inventors: Kylie Manning Kennedy, Downingtown, PA (US); Laura j. Donkus, Kutztown, PA (US); Michael A. Mallozzi, Hatfield, PA (US); Himal H. Ray, Collegeville, PA (US)

(21) Appl. No.: 18/699,992

(22) PCT Filed: Nov. 2, 2022
(86) PCT No.: PCT/US2022/079123

§ 371 Date: Apr. 10, 2024

Related U.S. Application Data
(60) Provisional application No. 63/265,036, filed on Dec. 7, 2021.

(51) Int. Cl. C08F 226/10; C08F 2/24; C08F 212/08; C08F 220/06; C08F 220/14; C08F 220/18; C08F 220/20; C09J 7/38; C09J 139/06

(52) U.S. Cl. CPC C08F 226/10; C08F 2/24; C08F 212/08; C08F 220/06; C08F 220/14; C08F 220/1804; C08F 220/1808; C08F 220/20; C09J 7/385; C09J 139/06; C09J 2203/334; C09J 2203/346; C09J 2203/354; C09J 2301/302; C09J 2433/00

(57) ABSTRACT

Provided is an aqueous composition comprising dispersed particles that comprise a polymer, wherein the polymer comprises, by weight based on the weight of the polymer, a) 60% to 99.95% polymerized units of one or more (meth)acrylate ester, b) 0.05% to 6% polymerized units of one or more N-vinyl lactam, c) 0% to 39.95% polymerized units of one or more other monomers. Also provided is a method of making that composition, a process for producing an article using that composition, and a method of bonding two substrates using that article.

A useful class of compositions are waterborne pressure sensitive adhesives (PSAs). Often, a layer of the waterborne PSA is applied to a substrate, and water is removed, leaving a layer of PSA present on the substrate. Common substrates are relatively thin, flat, and flexible, and often the resulting article is a tape or a label. One category of tapes are specialty tapes, such as those used in automotive and construction industries. Often, specialty tapes require both good cohesive strength, especially at high temperature, and good adhesive strength. Waterborne PSAs are generally considered to provide greater safety to workers and to involve less undesirable impact on the environment. Sometimes in the past it has been considered that waterborne PSAs could not provide the combination of properties desired for specialty tapes.

WO 2017/021487 describes a pressure sensitive adhesive composition comprising the emulsion polymerization product of a monomer mixture, the monomer mixture comprising: (a) at least one alkyl ester of (meth)acrylic acid; (b) at least one vinyl aromatic monomer; (c) at least one hydroxyl functional (meth)acrylate monomer; (d) at least one ureido substituted ethylenically unsaturated monomer; (e) at least one ethylenically unsaturated carboxylic acid; (f) at least one ethylenically unsaturated monomer different from monomers (a) to (e).

It is desired to provide an aqueous composition suitable as part or all of a waterborne PSA, where that PSA has both good adhesion and good high-temperature cohesive strength.

The following is a statement of the invention.

A first aspect of the present invention is aqueous composition comprising dispersed particles that comprise a polymer (I), wherein the polymer comprises, by weight based on the weight of the polymer (I),
a) 60% to 99.95% polymerized units of one or more (meth)acrylate ester,
b) 0.05% to 6% polymerized units of one or more N-vinyl lactam,
c) 0% to 39.95% polymerized units of one or more other monomers.

A second aspect of the present invention is a process for producing the composition of the first aspect, comprising an aqueous emulsion polymerization.

A third aspect of the present invention is a process for producing an article comprising the steps (A) applying a layer of the composition of the first aspect to a first substrate, and (B) removing water from the layer of the composition of claim 1.

A fourth aspect of the present invention is a method of bonding two substrates together comprising
I) providing an article produced by the process of the third aspect,
II) providing a second substrate separate from the substrate to which a layer of the composition of the first aspect was applied, and
III) bringing the second substrate into contact with the layer of the composition of the first aspect from which water was removed.

The following is a detailed description of the invention.

As used herein, the following terms have the designated definitions, unless the context clearly indicates otherwise.

As used herein, a composition is aqueous if it contains 40% or more water by weight based on the weight of the composition. Particles are said herein to be dispersed in a liquid medium if the liquid medium is continuous and the solid particles are distributed throughout the liquid medium. The dispersed particles may be solid or may be liquid that is poorly soluble in the liquid medium. A liquid is considered poorly soluble if 1 gram or less will dissolve in 100 grams of the liquid medium at 25° C. A composition in which particles are dispersed in a liquid medium may be an emulsion, a dispersion, a slurry, a latex, some other type of composition, or a combination thereof. A liquid medium is defined herein as an aqueous medium if the liquid medium contains 50% or more water, by weight based on the weight of the liquid medium.

The solids of a composition is the percent by weight, based on the total weight of the composition, of the composition that remains after all compounds having boiling point of 120° C. or lower have been removed from the composition.

As used herein, a polymer is a relatively large molecule made up of the reaction products of smaller chemical repeat units. Polymers may have structures that are linear, branched, star shaped, looped, hyperbranched, crosslinked, or a combination thereof; polymers may have a single type of repeat unit (homopolymers) or they may have more than one type of repeat unit (copolymers). Copolymers may have the various types of repeat units arranged randomly, in sequence, in blocks, in other arrangements, or in any mixture or combination thereof. A polymer has number-average molecular weight of 1,000 or higher.

As used herein, the phrase “weight of polymer” means the dry weight of polymer. The glass transition temperature (Tg) of a polymer is measured by dynamic scanning calorimetry at 10° C. per minute, using the midpoint method.

Molecules that can react with each other to form the repeat units of a polymer are known herein as monomers. The repeat units so formed are known herein as polymerized units of the monomer. The phrase “Tg of a monomer” refers to the Tg of a homopolymer made from that monomer.

The term (meth)acrylic means acrylic or methacrylic or a mixture thereof. The term (meth)acrylate means acrylate or methacrylate or a mixture thereof. A (meth)acrylate ester has structure (I):

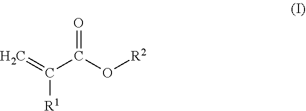

where R¹ is hydrogen or methyl and R² is a substituted or unsubstituted C₁ to C₂₀ alkyl group. Substituents may be, for example, halogen atoms, hydroxyl groups, amine groups, carboxyl groups, vinyl groups, sulfonic acid groups, other organic groups, or mixtures thereof. When R² is substituted with one or more hydroxyl groups, the resulting compound is known herein as a hydroxyl-substituted (meth)acrylate ester.

A vinyl aromatic compound is any compound having one or more aromatic ring and one or more vinyl group. An olefin monomer is a hydrocarbon compound having one or more one double bonds and no triple bonds. A polymer that contains polymerized units of one or more olefin monomers in an amount, by weight based on the weight of the polymer, of 50% or more is a polyolefin.

An N-vinyl lactam is a compound having structure (II):

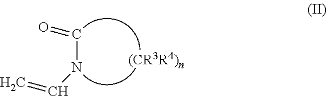

where n is 3, 4, or 5, and where each R³ and each R⁴, independently of every other R³ and R⁴, is hydrogen or an organic group containing 1 to 20 carbon atoms.

A crosslinker is a monomer having two or more polymerizable groups.

The ureido group is the chemical group NH₂—C(O)—NH—.

A tackifier is a substance added to composition in order to improve the tackiness of that composition.

A polyolefin emulsion is a composition in which polyolefin particles are dispersed in an aqueous medium.

Aqueous emulsion polymerization is a process of forming polymer. In aqueous emulsion polymerization, a monomer emulsion is formed in which droplets containing one or more monomers are dispersed throughout an aqueous medium. An initiator is a compound that is relatively stable under ambient conditions but that reacts to form free radicals that initiate polymerization, under one or more stress conditions such as, for example, elevated temperature exposure to ionizing radiation, or exposure to a compound that reacts with the initiator, or a combination thereof. In aqueous emulsion polymerization, polymer particles are formed outside of the droplets of monomer.

Emulsion polymerization may be performed either as a one-stage process or a multi-stage process. In a one-stage process, all of the monomer (or mixture of monomers) intended for use is brought into contact with initiator in a vessel under polymerization conditions (i.e., conditions that cause the initiator to form free radicals and initiate polymerization). In a one-stage process, no additional monomer is added.

In a multi-stage process, in a first stage, a first monomer (or first mixture of monomers) is brought into contact with initiator in a vessel under polymerization conditions, and some first polymer is formed. In a second stage, usually in the same vessel, some second monomer (or second mixture of monomers) and some initiator are brought into contact with each other under polymerization conditions in the presence of the first polymer. In the second stage, fresh initiator may be added, or initiator may be present, left over from the first stage. The second monomer (or second mixture of monomers) is usually different from the first monomer (or first mixture of monomers). Subsequent stages involve addition of further monomers (or mixtures of monomers), in the presence of initiator and the polymers formed in previous stages. Any stage may be performed as a batch polymerization or as a gradual addition polymerization.

A polymer sample may be characterized by the number of phases it contains. Plural phases are present when, for example, two polymers of different compositions are present in the sample, and the two compositions are not fully miscible. One suitable method of detecting the number of phases is by performing dynamic mechanical analysis (DMA) in shear at 10 sec⁻¹, with parameters adjusted to insure the sample is behaving in a linear viscoelastic manner. The DMA measurement is made at a variety of temperatures, and the dependence of tan(delta) is observed versus temperature. Plural peaks in tan(delta) versus temperature correspond to plural phases in the sample.

The present invention involves an aqueous composition that contains dispersed particles. The particles contain polymer (I), and the polymer (I) contains polymerized units of one or more (meth)acrylate ester. Preferably the amount of polymerized units of all (meth)acrylate esters in polymer (I) is, by weight based on the weight of the polymer (I), 60% or more; more preferably 70% or more; more preferably 80% or more. The amount of polymerized units of all (meth)acrylate esters in polymer (I) is, by weight based on the weight of the polymer (I), 99.95% or less; preferably 98% or less; more preferably 96% or less.

Among the (meth)acrylate esters, preferably one or more unsubstituted alkyl esters of methacrylic acid is used. Preferred unsubstituted alkyl esters of methacrylic acid have Tg of 30° C. or higher; more preferably 50° C. or higher; more preferably 70° C. or higher. With reference to structure (I) above, unsubstituted alkyl esters of methacrylic acid may be characterized by NCMR2, the number of carbon atoms in the R² group. Preferably NCMR2 is 3 or less; more preferably 2 or less; more preferably 1. Preferably the amount of polymerized units of unsubstituted alkyl esters of methacrylic acid in polymer (I) is, by weight based on the weight of the polymer (I), 0.5% or more; more preferably 1% or more; more preferably 2% or more. Preferably the amount of polymerized units of unsubstituted alkyl esters of methacrylic acid in polymer (I) is, by weight based on the weight of the polymer (I), 15% or less; more preferably 12% or less, more preferably 9% or less.

Among the (meth)acrylate esters, preferably one or more unsubstituted alkyl esters of acrylic acid is also used. Preferred unsubstituted alkyl esters of acrylic acid have Tg of 0° C. or lower; more preferably −15° C. or lower; more preferably −30° C. or lower. Preferably the amount of polymerized units of unsubstituted alkyl esters of acrylic acid in polymer (I) is, by weight based on the weight of the polymer (I), 60% or more; more preferably 70% or more; more preferably 80% or more. With reference to structure (I) above, unsubstituted alkyl esters of acrylic acid may be characterized by NCAR2, the number of carbon atoms in the R² group. Preferably NCAR2 is 3 or more; more preferably 4 or more. Preferably NCAR2 is 12 or less; more preferably 10 or less; more preferably 8 or less. Preferably the amount of polymerized units of unsubstituted alkyl esters of acrylic acid in polymer (I) is, by weight based on the weight of the polymer (I), 99.45% or less; more preferably 97.95% or less; more preferably 96.95% or less. Preferably the amount of polymerized units of unsubstituted alkyl esters of acrylic acid in polymer (I) is, by weight based on the weight of the polymer (I), 45% or more; more preferably 48% or more; more preferably 51% or more.

The polymer (I) also contains polymerized units of one or more N-vinyl lactam. In structure (II) (shown above), preferably n is 3 or 5; more preferably 3. In structure (II), preferably each R³ and R⁴ is, independently of every other R³ and R⁴, hydrogen or unsubstituted alkyl having 1 to 4 carbon atoms; more preferably, hydrogen or methyl. Preferably, the total number of R³ and R⁴ groups that are any group other than hydrogen is 3 or less; more preferably 2 or less; more preferably 1 or 0; more preferably 0. Among the suitable N-vinyl lactams are, for example, N-vinyl pyrrolidone; N-vinyl caprolactam; 1-vinyl-2-piperidone; 1-vinyl-5-methyl-pyrrolidone; and mixtures thereof. Preferred is N-vinyl pyrrolidone.

The polymer (I) contains polymerized units of N-vinyl lactam in an amount, by weight based on the weight of the polymer (I), of 0.05% or more; preferably 0.1% or more; more preferably 0.2% or more. The polymer (I) contains polymerized units of N-vinyl lactam in an amount, by weight based on the weight of the polymer (I), of 6% or less; preferably 3% or less; more preferably 1.5% or less.

The polymer (I) optionally contains polymerized units of one or more hydroxyl-substituted (meth)acrylate ester. In some preferred embodiments, little or no hydroxyl-substituted (meth)acrylate ester is used; that is, in those embodiments, the amount of polymerized units of hydroxyl-substituted (meth)acrylate ester in the polymer (I) is, by weight based on the weight of the polymer, 0% to 0.1%; more preferably 0% to 0.02%; more preferably 0% to 0.01%; more preferably 0%. In other embodiments, one or more hydroxyl-substituted (meth)acrylate is used in amounts large than 0.1%, and the amount of polymerized units of hydroxyl-substituted (meth)acrylate ester in the polymer (I), by weight based on the weight of the polymer, is 5% or less; more preferably 4% or less.

The polymer (I) optionally contains polymerized units of (meth)acrylic acid. When (meth)acrylic acid is used, preferred is acrylic acid. When (meth)acrylic acid is used, preferably the amount of polymerized units of (meth)acrylic acid in the polymer (I) is, by weight based on the weight of polymer (I), 0.1% or more; more preferably 0.2% or more; more preferably 0.5% or more; more preferably 1% or more. When (meth)acrylic acid is used, preferably the amount of polymerized units of (meth)acrylic acid in the polymer (I) is, by weight based on the weight of polymer (I), 10% or less; more preferably 8% or less; more preferably 6% or less.

The polymer (I) preferably contains polymerized units of one or more vinyl aromatic monomer. Preferred vinyl aromatic monomers are styrene and alpha-methyl styrene; more preferred is styrene. Preferably the amount of polymerized units of vinyl aromatic monomer in the polymer (I) is, by weight based on the weight of polymer (I), 0.2% or more; more preferably 0.5% or more; more preferably 1% or more; more preferably 2% or more. Preferably the amount of polymerized units of vinyl aromatic monomer in the polymer (I) is, by weight based on the weight of polymer (I), 20% or less; more preferably 15% or less; more preferably 10% or less.

The polymer (I) optionally contains polymerized units of one or more olefin monomer. Preferred olefin monomers are ethylene, propylene, dienes, and mixtures thereof. When olefin monomers are used, preferably the amount of polymerized units of olefin monomer in polymer (I) is, by weight based on the weight of the polymer (I), 0% to 10%; more preferably 0% to 5%; more preferably 0% to 2%; more preferably 0% to 1%.

Polymer (I) may or may not contain polymerized units of one or more crosslinker.

Preferably, the polymer (I) contains little or no attached ureido groups. That is, preferably the amount of ureido groups attached to the polymer (I) is, by weight based on the weight of the polymer (I), 0% to 0.02%; more preferably 0% to 0.1%; more preferably 0% to 0.05%; more preferably 0%.

The weight of the polymer (I) in the aqueous composition is, based on the total weight of the aqueous composition, 10% or more; more preferably 20% or more. The weight of the polymer (I) in the aqueous composition is, based on the total weight of the aqueous composition, 55% or less; more preferably 50% or less; more preferably 45% or less.

The polymer may be assessed to determine the number of phases. The preferred method of assessing the number of phases involves making a solid sample of the polymer by removing water and any other volatile compounds and then performing DMA on the solid sample as described above.

The polymer may be made by any method. The preferred method is aqueous emulsion polymerization. Preferred emulsion polymerization is a one-stage or a multi-stage aqueous emulsion polymerization. When a one-stage polymerization is used, the polymer formed will be polymer (I).

When a multi-stage polymerization is used, the polymer formed in one or more of the stages will be suitable as polymer (I). A stage that produces polymer (I) may or may not be the first stage to be performed in the polymerization. A polymer that is produced in a stage that does not produce polymer (I) is labeled herein “polymer (II).” One or more polymer (II) may be produced.

It is contemplated that, when a multi-stage polymerization is used, in some instances the polymers produced form a single phase, and in other instances the polymers produced will form more than one phase.

Embodiments in which more than one polymer phase is present are known herein as “multi-phase embodiments.” Some multi-phase embodiments are formed by a process that includes one or more multi-stage polymerization.

Also envisioned are multi-phase embodiments that are formed by a process that includes blending two or more polymers after polymerization of the separate polymers is complete. For example, two or more aqueous emulsion polymerization processes may be completed in separate vessels. In one or more of the vessels, one or more polymer is present that meets the criteria for polymer (I). After the contents of the vessels are mixed together, a polymeric sample is formed that contains two or more phases, possibly after one or more subsequent steps such as, for example, drying.

In some multi-phase embodiments (“crosslinked embodiments”), one or more polymer (II) contains polymerized units of one or more crosslinker. Suitable crosslinkers include, for example, divinyl benzene, allyl methacrylate, and mixtures thereof. Preferably, in crosslinked embodiments, one or more polymer (II) is present in which the amount of crosslinker in polymer (II) is, by weight based on the weight of that polymer (II), 0.1% to 10%. In some multi-phase embodiments (“high-Tg embodiments”), one or more polymer (II) has Tg of 20° C. or higher; more preferably 50° C. or higher; more preferably 80° C. or higher. Various multi-phase embodiments are envisioned. For example, a multi-phase embodiment may or may not be either or both a crosslinked embodiment and a high-Tg embodiment.

The aqueous composition of the present invention preferably comprises one or more tackifiers, one or more polyolefin emulsions, or a mixture thereof. Preferred tackifiers are rosin acids, rosin esters, terpenes, hydrocarbon-based tackifiers, and mixtures thereof. Preferred polyolefin emulsions contain dispersed particles of polyolefin in an aqueous medium. Preferably, in a polyolefin emulsion, the dispersed particles of polyolefin contain polymerized units that contain, by weight based on the weight of polyolefin, polymerized units that are either 50% or more polymerized units of ethylene or 50% or more polymerized units of propylene. Preferred polyolefin emulsions contain polyolefin that contains polymerized units of one or more monomer having a carboxyl group, such as, for example, (meth)acrylic acid.

Preferably, the combined dry weight of tackifiers and polyolefins is, based on the total weight of the aqueous composition, 0.3% or more; more preferably 1% or more; more preferably 3% or more. Preferably, the combined dry weight of tackifiers and polyolefins is, based on the total weight of the aqueous composition, 30% or less; more preferably 20% or less; more preferably 10% or less.

The aqueous composition of the present invention may be used for any purpose. Preferred uses involve making an article that has one surface coated with a dried layer of the aqueous composition. The item, prior to coating, is known as a substrate. Preferred substrates have thickness of 5 mm or less; more preferably 2 mm or less. Preferred substrates are polymer films, fabrics, and paper. Preferably the amount of dried layer of the aqueous composition on the surface of the substrate is, in grams per square meter, 2 or more; more preferably 5 or more; more preferably 10 or more. Preferably the amount of dried layer of the aqueous composition on the surface of the substrate is, in grams per square meter, 125 or less; more preferably 100 or less; more preferably 75 or less. It is considered that the dried layer of the aqueous composition will function as a PSA. The article having a layer of such a PSA may be, for example, a tape or a label.

Among tapes made according to the present invention, some are suitable for specialty applications such as, for example, use in the automotive and/or construction industries. Specialty tapes typically have an amount of dried layer of the aqueous composition on the surface of the substrate of 30 or more grams per square meter. Many specialty tapes have relatively good performance at high temperature, which is often assessed using the SAFT (Shear Adhesion Failure Temperature).

In some cases, a specialty tape may be made by transfer coating, which is a process in which the aqueous composition of the present invention is coated onto a release liner and dried. The release liner is chosen so that the dried composition of the present invention will adhere poorly to the surface of the release liner. Then the dried composition of the present invention is brought into contact with a new substrate, and the release liner is removed, thus the dried composition of the present invention transfers to the new substrate. The new substrate, with a dried layer of the composition of the present invention adhered to a surface, is then the desired tape.

An article that has a substrate and a dried layer of the aqueous composition of the present invention may be made by any method. Preferably, a layer of the aqueous composition is applied to a surface of a substrate. Preferably, water is then removed from the applied layer. Water may be removed by any method, including, for example, applying heat, applying moving air, exposure to infrared radiation, or a combination thereof. Preferably, the amount of water remaining in the layer of the aqueous composition after drying is, by weight based on the weight of the dried composition, 10% or less; more preferably 5% or less; more preferably 3% or less.

The article having a layer of the dried aqueous composition may be used for any purpose. A preferred purpose is to bond together the first substrate (i.e., the substrate on which the dried aqueous composition already resides) to a second substrate, which is a separate item from the first substrate. This bonding is accomplished by bringing the second substrate into contact with the layer of dried aqueous composition. Optionally, mechanical force may be applied for a time, to drive the two substrates toward each other.

The following are examples of the present invention. Operations were performed at room temperature (approximately 23° C.) except where otherwise stated.

In the following examples, the following materials were used:

| Name | Description |
|---|---|
| DOWFAX ™2A1 | surfactant (Dow Chemical Co.) |
| ABEX ™ 2535 | surfactant (Solvay) |
| 2-EHA | 2-ethylhexyl acrylate |
| BA | n-butyl acrylate |
| MMA | methyl methacrylate |
| Sty | styrene |
| AA | acrylic acid |
| HEA | 2-hydroxyethyl acrylate |
| UM | ureido methacrylate (N-(2-Methacryloyloxyethyl) |
| | ethylene urea) |
| NVP | N-vinyl pyrrolidone |
| PET | polyethylene terephthalate |
| SS | stainless steel |
| HDPE | high density polyethylene |

Comparative Example 1: A pre-emulsion was formed by mixing 531.99 g water, 58.42 g Dowfax 2A1 (from Dow), 10.58 g Abex 2535 (from Solvay), 874.9 g 2-EHA, 621.2 g BA, 135.7 g MMA, 52.4 g Sty, 26.22 g AA, 35.0 g HEA, and 4.35 g ureido methacrylate. Two separate solutions were prepared: (A) 5.29 g sodium persulfate in 126.04 g water and (B) 3.45 g sodium persulfate in 31.51 g water. 802.7 g water and 2.3 g Dowfax 2A1 surfactant were charged to the reactor. Nitrogen purge was started, and the reactor was heated to 78° C. At 78° C., 71.3 g of the pre-emulsion was added to the reactor. Solution B was charged to the kettle and flushed with 6.9 g water. Nitrogen purge was turned off, and the reaction exotherm began. 15 minutes after the exotherm peaked, the mixture from pre-emulsion tank and solution A was flowed into the reactor for 3.5 hours and the reactor temperature was controlled at 85° C. After the flow was complete, the pre-emulsion was flushed with 18.4 g water and the reactor was held at 87° C. for 45 minutes. After the hold, the temperature was cooled. At 85° C. a solution of 0.069 g ferrous sulfate heptahydrate and 0.069 g EDTA dissolved in 4.6 g water was added to the reactor. Solution (C) 6.21 g t-butyl hydroperoxide in 46 g water and (D) 2.76 g sodium formaldehyde sulfoxylate in 36.8 g water were prepared. Flow of solutions C and D to the reactor over 45 minutes was started and the temperature was maintained above 70° C. for the entire feed. After the feed, the reactor was held for another 15 minutes. The reactor was cooled to room temperature and the pH was adjusted to 6.0-8.0 with 28% aqueous ammonium solution.

Comparative Example 2 was prepared using the same method as in Comparative Example 1 with different monomer compositions set forth in the Table below.

Inventive Example 1: A pre-emulsion was formed by mixing 531.99 g water, 58.42 g Dowfax 2A1 (from Dow), 10.58 g Abex 2535 (from Solvay), 874.9 g 2-EHA, 621.2 g BA, 135.7 g MMA, 52.4 g Sty, 26.22 g AA, 35.0 g HEA, and 4.35 g N-vinyl pyrrolidone. Two separate solutions were prepared: (A) 5.29 g sodium persulfate in 126.04 g water and (B) 3.45 g sodium persulfate in 31.51 g water. 802.7 g water and 2.3 g Dowfax 2A1 surfactant were charged to the reactor. Nitrogen purge was started, and the reactor was heated to 78° C. At 78° C., 71.3 g of the pre-emulsion was added to the reactor. Solution B was charged to the kettle and flushed with 6.9 g water. Nitrogen purge was turned off, and the reaction exotherm began. 15 minutes after the exotherm peaked, the mixture from pre-emulsion tank and solution A was flowed into the reactor for 3.5 hours and the reactor temperature was controlled at 85° C. After the flow was complete, the pre-emulsion was flushed with 18.4 g water and the reactor was held at 87° C. for 45 minutes. After the hold, the temperature was cooled. At 85° C. a solution of 0.069 g ferrous sulfate heptahydrate and 0.069 g EDTA dissolved in 4.6 g water was added to the reactor. Solution (C) 6.21 g t-butyl hydroperoxide in 46 g water and (D) 2.76 g sodium formaldehyde sulfoxylate in 36.8 g water were prepared. Flow of solutions C and D to the reactor over 45 minutes was started and the temperature was maintained above 70° C. for the entire feed. After the feed, the reactor was held for another 15 minutes. The reactor was cooled to room temperature and the pH was adjusted to 6.0-8.0 with 28% aqueous ammonia solution.

Inventive Examples 2, 3, 4, 5 and 6 were prepared using the same method as in Inventive Example 1 with different monomer compositions set forth in the Table below. The amounts shown are percent by weight based on the total weight of monomer. “Comp.” means comparative; “Inv” means inventive.

| Example | 2-EHA | BA | MMA | Sty | AA | HEA | UM | NVP |
|---|---|---|---|---|---|---|---|---|
| Comp 1 | 50 | 35.5 | 7.75 | 3 | 1.5 | 2 | 0.25 | — |
| Comp 2 | 50 | 35.75 | 7.75 | 3 | 1.5 | 2 | — | — |
| Inv 1 | 50 | 35.5 | 7.75 | 3 | 1.5 | 2 | — | 0.25 |
| Inv 2 | 50 | 35.25 | 7.75 | 3 | 1.5 | 2 | — | 0.50 |
| Inv 3 | 50 | 35 | 7.75 | 3 | 1.5 | 2 | — | 0.75 |
| Inv 4 | 50 | 35.25 | 5.75 | 5 | 1.5 | 2 | — | 0.50 |
| Inv 5 | 50 | 35.25 | 3.75 | 7 | 1.5 | 2 | — | 0.50 |
| Inv6 | 50 | 37.25 | 7.75 | 3 | 1.5 | — | — | 0.50 |

The experimental procedures were as follows.

The samples were tested by direct coating onto PET film of thickness 50 micrometers (2 mil), drying in a 110° C. oven for 3 minutes with a target dried adhesive coat weight of 20 g/m². The coated PET was laminated to release liner. The PET/adhesive/liner construction was cut into strips of width 25.4 mm (1 inch), the release liner was removed, and the PET film with adhesive was laminated to stainless steel (SS) for peel testing based on the method PSTC-lOl with 15-minute and 24-hour dwell time. After adhering to the test panel, it was rolled twice by 2 kg weight roller. 180 degree peel was run at the specified dwell time with an Instron tester. Peel results are reported in Newtons per width of 25.4 mm (labeled “N/in”).

The sample strips were also tested for SAFT (Shear Adhesion Failure Temperature) using the method PSTC-17. A strip was cut of width 25.4 mm (1 inch) wide strip with length of 152.4 mm (6 inch). It was adhered to stainless steel panel with 25 mm by 25 mm (1 inch by 1 inch) contact area and then rolled twice by 2.0 kg (4.5 lb) weight roller. The steel panel with the strip was held in a rack in a 40° C. oven such that the panel formed an angle of 178 degrees to 180 degrees. Then the 1-kg weight was hung on the strips. The oven was programmed to hold at 40° C. for 20 minutes immediately after the weight was hung. After the 20 minutes hold, the oven temperature increased at a rate of 0.5° C. per minute. When the oven temperature reached 20° C., the test was completed and the oven started to cool. When the 1-kg weight dropped due to the failure of test strips on steel panel, the temperature was recorded as SAFT. If test strip did not fail throughout the course of temperature rise, the SAFT is recorded as 205+° C.

Loop tack was tested using PSTC-16B. The Loop tack test involves a loop of tape having width of 25.4 mm (1 inch), which is initially adhered to a substrate with a contact area of 645 mm² (1 in²). The Loop Tack result reported herein is the maximum force exerted during removal of the tape, reported in units of “Newtons per inch” (N/in). All PSTC methods are from Pressure Sensitive Tape Council (Chicago, IL, USA).

Tested Property Results are shown in the table below. On all samples, coating weight was 20 grams per square meter. The following abbreviations are used:

| Sample | SAFT (° C.) | SS Peel (20 min) (N/in) | | SS Peel (24 hr) (N/in) | |
|---|---|---|---|---|---|
| Comp 1 | 205+ | 1.5 | A | 3.7 | A |
| Comp 2 | 205+ | 6.3 | A | 10.3 | A |
| Inv 1 | 205+ | 6.8 | A | 17.9 | AFB/A |
| Inv 2 | 205+ | 8.5 | A | 18.4 | sl AFB |
| Inv 3 | 205+ | 8.7 | A | 20.7 | half AFB |
| Inv 4 | 205+ | 8.4 | A | 17.3 | sl AFB |
| Inv 5 | 205+ | 9.2 | A | 22.5 | half AFB |
| Inv 6 | 172 | 10.0 | A | 24.1 | AFB |

A = Adhesive (adhesive removes cleanly from SS)
AFB = Adhesive from Backing (adhesive comes cleanly off PET and sticks to SS)
sl = slight

Additional test results were as follows. Loop tack is reported as Newtons per an area of 645 mm², reported as “N/in².”

| | HDPE Peel (20 | HDPE Peel | SS Loop | HDPE Loop |
|---|---|---|---|---|
| Sample | min) (N/in) | (24 hr) (N/in) | Tack (N/in) | Tack (N/in) |
| Comp 1 | 0.4 A | 0.2 A | 4.5 A | 3.2 A |
| Comp 2 | 1.3 A | 2.1 A | 7.4 A | 3.7 A |
| Inv 1 | 2.1 A | 2.3 A | 6.8 A | 6.1 A |
| Inv 2 | 2.1 A | 2.8 A | 6.1 A | 6.5 A |
| Inv 3 | 2.5 A | 3.7 A | 7.0 A | 5.9 A |
| Inv 4 | 2.8 A | 4.9 A | 6.8 A | 4.4 A |
| Inv 5 | 2.4 A | 3.1 A | 6.3 A | 5.8 A |
| Inv 6 | 2.3 A | 3.9 A | 8.5 A | 6.1 A |

SS peel—The inventive examples using vinyl pyrrolidone (NVP) (Inventive examples 1-6) have greater SS peel at both 20 min and 24 hr dwell times compared to the comparative examples 1 and 2 using a combination of HEA and ureido monomer or HEA alone. Comparative example 1 is considered to be representative of the polymers disclosed in WO 2017/021487.

HDPE peel—The inventive examples using N-vinyl pyrrolidone (Inventive examples 1-6) have significantly greater HDPE peel at both 20 min and 24 hr dwell times than the comparative examples.

SS loop tack and HDPE loop tack—The inventive examples using N-vinyl pyrrolidone (inventive examples 1-6) have superior loop tack on both SS and HDPE compared to comparative example 1 containing a combination of ureido and hydroxy monomer. The inventive examples using N-vinyl pyrrolidone (inventive examples 1-6) have superior loop tack on HDPE and comparable or superior loop tack on SS compared to comparative example 2.

SAFT—The inventive examples (Inventive examples 1-6) have a high SAFT performance, while providing a considerable improvement in adhesion.

1. An aqueous composition comprising:
dispersed particles that comprise a polymer (I), wherein the polymer comprises, by weight based on the weight of the polymer (I),
a) 60% to 99.95% polymerized units of one or more (meth)acrylate ester,
b) 0.05% to 6% polymerized units of one or more N-vinyl lactam,
c) 0% to 39.95% polymerized units of one or more other monomers.

2. The aqueous composition of claim 1, wherein the polymer comprises, by weight based on the weight of the polymer (I),
a1) 45% to 98.95% polymerized units of one or more acrylate ester, and
a2) 1 to 15% polymerized units of one or more methacrylate ester.

3. The aqueous composition of claim 1, wherein the polymer (I) contains 0 to 0.02% ureido groups, by weight based on the weight of the polymer (I).

4. The aqueous composition of claim 1, wherein the aqueous composition additionally comprises one or more tackifier, one or more polyolefin emulsion, or a combination thereof.

5. A process for producing the composition of claim 1, comprising an aqueous emulsion polymerization.

6. A process for producing an article comprising:
A) applying, to a first substrate, a layer of an aqueous composition comprising
dispersed particles that comprise a polymer (1), wherein the polymer comprises, by weight based on the weight of the polymer (1),
a) 60% to 99.95% polymerized units of one or more (meth)acrylate ester,
b) 0.05% to 6% polymerized units of one or more N-vinyl lactam,
c) 0% to 39.95% polymerized units of one or more other monomers; and
B) removing water from the layer.

7. A method of bonding two substrates together comprising
I) providing an article produced by the process of claim 6,
II) providing a second substrate separate from the substrate to which the layer was applied, and
III) bringing the second substrate into contact with the layer from which water was removed.
